(19) United States
(12) Patent Application Publication
(10) Pub. No.: US 2002/0109775 A1
(43) Pub. Date: Aug. 15, 2002

(54) Back-lighted fiducial recognition system and method of use

(75) Inventors: Paul David White, Rancho Palos Verdes, CA (US); Huong Duc Vu, Garden Grove, CA (US)

Correspondence Address: LOWE HAUPTMAN GILMAN & BERNER, LLP, Suite 310, 1700 Diagonal Road, Alexandria, VA, 22314, US

(73) Assignee: Excellon Automation Co.

(21) Appl. No.: 09/779,635

(22) Filed: Feb. 9, 2001

(51) Int. Cl. H04N 7/18

(52) U.S. Cl. 348/87; 382/141

(57) ABSTRACT

A system is disclosed for exact positioning of a printed circuit board to be drilled utilizing a camera vision system. The fiducial is formed in a semi-opaque area of the circuit board panel that is free of copper or other metallic layer material on top and bottom surfaces thereof, enabling light to be directed upwardly through a transparent surface area of a vacuum chuck on which the panel is disposed. In this manner, the outline of the fiducial is silhouetted through this back lighted arrangement so that the camera vision system can easily ‘see’ the fiducial to communicate the precise location of the circuit board and enable movement of the vacuum chuck in X and Y directions to effect the desired precise drilling at predetermined locations on the panel.

### TECHNICAL FIELD

The present invention relates generally to a method and apparatus to facilitate the precise center positioning of a positive art work and, more particularly, to a system for precisely locating a printed circuit board fiducial for hole drilling purposes.

### BACKGROUND ART

There are a number of applications in which it is desirable to be able to laser drill holes in materials. For example, in electrical circuit interconnection packages such as printed circuit boards (PCBs), it is generally necessary to provide interconnection or microvia holes such as between dielectric layers of the package. These holes are often laser drilled and, typically, a large number of holes must be drilled to both interconnect layers or enable surface mounting of electronic components to the board.

The drilling operation is generally carried out on a table arranged to be moved in the direction of X and Y orthogonal axes by X and Y servo motors. The table supports a vacuum chuck on which one or more circuit board panels to be drilled are placed in singular or stacked fashion. The bottom facing surface of the board is formed with X and Y slots adapted to interengage one or more pins to effect exact positioning of the board on the vacuum chuck. However, it is then necessary for the laser drill to orient itself in relation to the panel so that the exact hole locations to be drilled in the board can be known.

In order to enable the drilling system to locate the position of drilling holes relative to the board panel, it is industry practice to form one or more fiducials in the board substrate. A fiducial mark is a printed art work feature which is created in the same process as the circuit artwork. Once the fiducial mark is located in a scanning process (preparatory to drilling for example), it can then provide common measurable points for all steps in the assembly process. This allows each piece of equipment used for assembly to accurately locate the circuit pattern.

In the industry, at the point that the panel is ready for drilling, one or more copper layers are disposed on both the top and bottom panel surfaces. The fiducials are formed in the board substrate and are hidden by the copper layers. A process known as “skiving” is then performed with the laser to remove the top copper layer and thereby expose the fiducial. The skiving process is typically repeated on each of the four corners of the panel. Consequently, an overhead light shining down onto the exposed fiducial provides illumination to enable an overhead camera vision system to ‘see’ the fiducial and thereby locate the drilling tools relative to the fiducial to drill the holes at proper locations.

The skiving process typically takes about one to two minutes per panel. Since hundreds of panels are drilled during a normal production run, both production time and cost are disadvantageously increased.

It is accordingly an object of the present invention to reduce production time and cost associated with locating and drilling holes in printed circuit board panels and similar materials.

Another object is to quickly and reliably orient a camera vision system in relation to one or more known points on the circuit board panel to provide precise positioning information to the drilling equipment.

### DISCLOSURE OF THE INVENTION

The present invention provides a method of precisely locating a printed circuit board panel containing at least one fiducial on a vacuum chuck of a drilling machine. The invention is suitable for both laser and mechanical drilling tools. The invention may also have utility for precisely locating other structures, in addition to printed circuit boards or printed wiring boards, in relation to other equipment with which other areas of the circuit board must be processed at known positions. In accordance with the preferred method of this invention, the circuit board panel is positioned on the vacuum chuck. An image of the fiducial disposed on the panel is then projected towards an overhead camera vision system by shining a light upwards through the fiducial from a light source located below the panel. By projecting the image in this manner, the fiducial is presented to the camera vision system as a silhouette or backlit image, enabling the vision system to locate itself and thereby subsequently the drilling tool at known positions on the panel.

It is industry practice to form fiducials in each of the four comers of the panel. Accordingly, once the overhead camera vision system records the location of the first fiducial, the system is then relatively moved to each of the other comers in succession which are similarly backlit to silhouette the fiducial and enable the positioning process to be completed in a fast and reliable manner without scithing.

In the preferred embodiment, the predetermined area of the panel containing the fiducial is positioned over a transparent surface portion of the vacuum chuck so that the light source can shine upwards through the transparent surface portion to silhouette the fiducial.

To precisely maintain the position of the fiducial on the vacuum chuck, another preferred feature of this invention involves applying vacuum directly to the predetermined fiducial containing area through the transparent surface portion.

The method and apparatus according to this invention are preferably useful as a means to eliminate the need for skiving. Accordingly, the predetermined area of the panel in which the fiducial is contained is preferably bare and formed free of any copper or any other metallic layer along top and bottom surfaces thereof. One manner of providing bare top and bottom surfaces may be by taping or masking these surfaces prior to application of copper or other metallic layers to the panel during earlier manufacturing steps.

The light source is preferably derived from a plurality of light sources positioned in a two dimensional array beneath the transparent surface portion of the vacuum chuck so that the light is more easily diffused to provide for even silhouetting or shadowing of the fiducial. Preferably, an array of high intensity LEDs are utilized as the light source. With the two dimensional light array, a relatively large predetermined surface area (e.g. 50 mm×50 mm or more) of the transparent surface portion is provided with an even amount of diffused light which will greatly facilitate the use of the same vacuum chuck for drilling operations on different sized panels for ease of positioning during set up.

In accordance with the method and apparatus of this invention, the transparent surface portion is preferably clear. However, depending on the particular application, it is also possible for the transparent surface portion to be colored or, in the alternative, to shine colored light through a clear transparent surface portion.

In addition to the method described above, the present invention also is directed to a laser drilling apparatus comprising a laser radiation source for generating a laser beam, and a motorized table positioned beneath the laser beam on which is supported a vacuum chuck positioned to receive a circuit board panel to be drilled thereon. The circuit board panel includes a fiducial at one or more locations, preferably each of the four panel corners. A light source is positioned below a panel support upper surface of the vacuum chuck for transmitting light upwardly to backlight a portion of the panel containing a fiducial. An overhead camera vision system detects the position of the fiducial to determine the exact positioning of the panel on the table and orient the vision system relative to a known point on the panel. In this manner, a scanner operatively connected to the camera vision system is used to point the laser beam at precise known locations where it is desired to drill holes in the panel.

One or more vacuum passageways are preferably formed within the transparent surface portion of the vacuum chuck to enable vacuum to positively seat the portion of the panel containing the fiducial onto the backlit area of the chuck. In this manner, a clear shadow image or silhouette of the fiducial may be detected by the overhead vision system.

In the preferred embodiment, the vacuum chuck is respectively provided with four transparent backlit surface portions in predetermined surface areas of the chuck. These areas are positioned relative to each other to effectively underlie the four corners of a panel to be drilled. By providing each of the transparent surface portions with a two dimensional array of multiple light sources, preferably high intensity LEDs, in a sufficiently large surface area, the chuck is advantageously operable to evenly backlight the fiducials of differently sized boards that a particular manufacturer plans to drill during specific production runs.

Still other objects and advantages of the present invention will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a schematic representational perspective view of a method and apparatus for locating fiducials in printed circuit board panels in accordance with the features of the present invention;

FIG. 2 is a scaled top plan view of a vacuum chuck embodying the features of the present invention;

FIG. 3 is an enlarged cross sectional view taken along the lines of 3-3 of FIG. 2 to depict the structure of a representative transparent back lit surface portion of the vacuum chuck used in the invention;

FIG. 4 is a detailed top plan view of the light assembly in the back lighting display of FIG. 2; and

FIG. 5 is a side elevation view of the light assembly of FIG. 4.

### BEST MODE FOR CARRYING OUT THE INVENTION

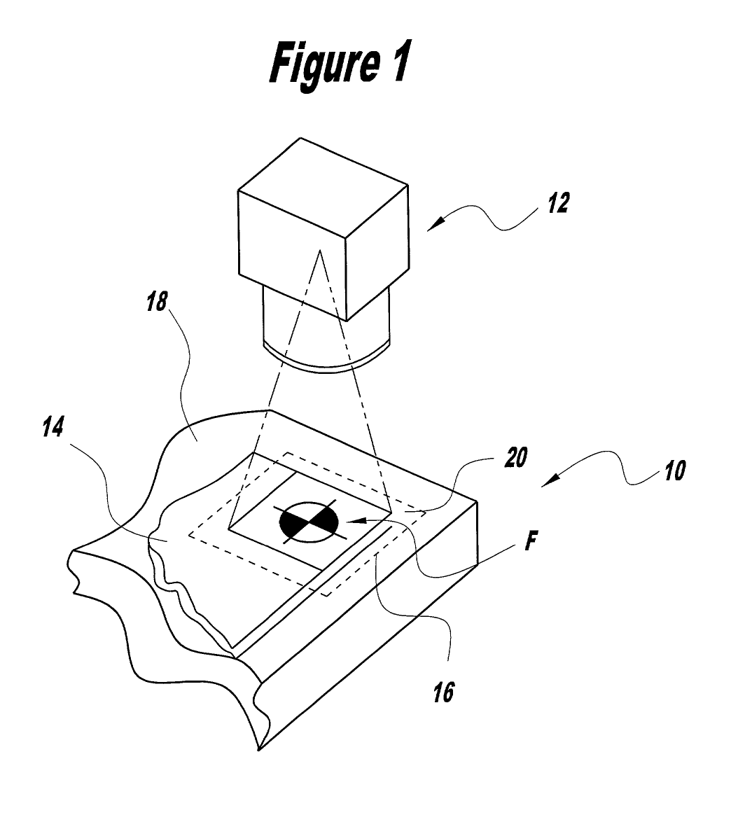

Referring to FIG. 1, the present invention utilizes a unique backlighting assembly, generally designated with reference numeral 10, in combination with a conventional overhead camera vision system 12, to locate circuit board fiducials F which are typically located internally in each corner of the circuit board panel 14. The backlighting assembly 10 is comprised of a lighting panel 16 mounted in the vacuum chuck 18 beneath a transparent surface portion that may be formed from a clear acrylic panel 20 located at each of four spaced locations on the vacuum chuck that approximate the areas in which the fiducials F of a circuit board panel 14 to be drilled would be located when the panel is placed on the vacuum chuck. The light shining upwardly through the transparent surface portion 20 backlights or silhouettes the fiducial F. This backlight allows the vision system 12 to locate the fiducial F in an otherwise known manner. Once the fiducial F is located at one of the corners, the vision system 12 is successively indexed to each of the other three corners to locate the associated fiducial F and thereby properly orient the drilling implement for precise positioning and drilling of holes into the panel 14.

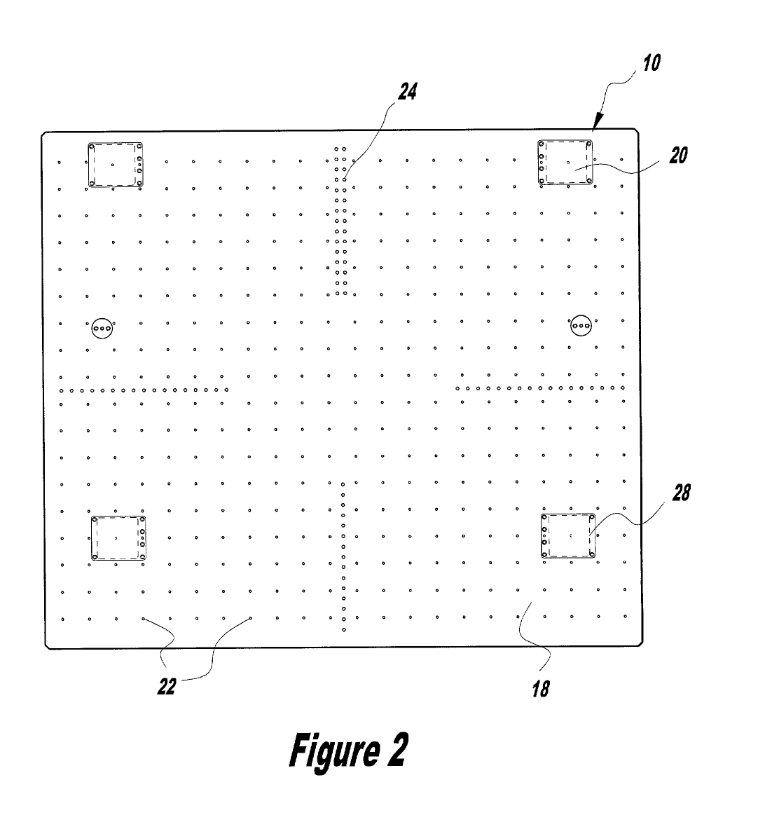

With reference to FIG. 2, the vacuum chuck 18 is of generally conventional instruction in the sense that it is formed with a series of vacuum chambers that may be selectively actuated to apply vacuum to a series of vacuum openings 22 formed in an upper portion of the vacuum chuck in communication with a top surface thereof. Vacuum is 18 used in a known manner to securely mount the panel 14 to be drilled to the vacuum chuck 18. A series of pins 24 which are divided into first and second pairs spaced from each other along X and Y coordinate axes on the chuck 18 are engageable with corresponding slots formed in the panel bottom in a known manner to properly orient the panel on the chuck before vacuum is applied to maintain this positioning.

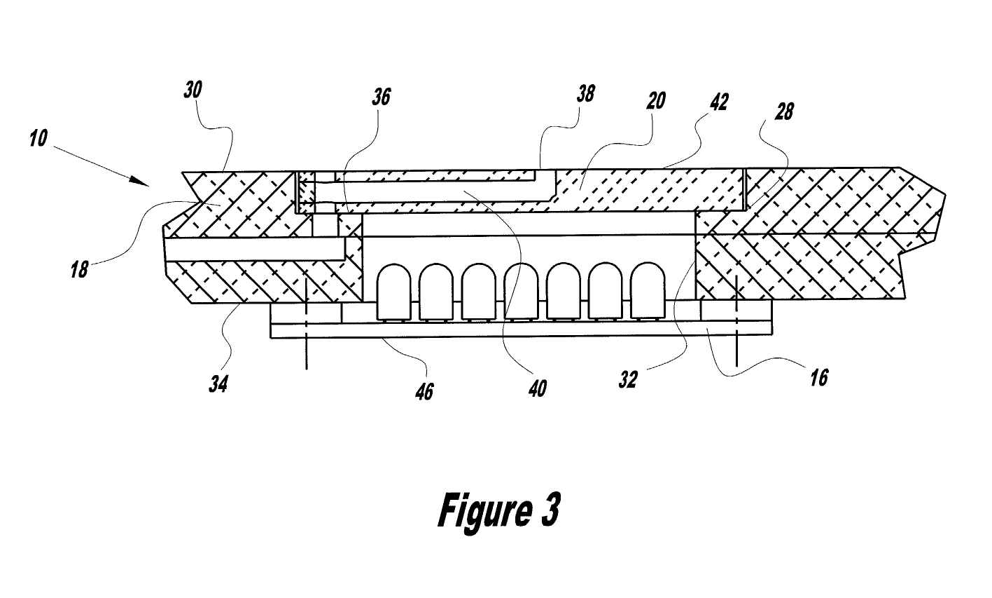

In addition to the pins 24 and vacuum openings 22 described hereinabove which are of conventional construction, the vacuum chuck 18 is unique with respect to the incorporation of the backlighting assemblies 10 described above. With reference to the detailed cross sectional view depicted in FIG. 3, each backlighting assembly 10 is formed with an upwardly directed recess 28 in the top surface 30 of the vacuum chuck 18. The recess 28 is preferably rectangular in plan view (FIG. 2) but other configurations are possible. The recess bottom is in open communication with a through opening 32 extending to the bottom side 34 of the vacuum chuck 18. This through opening 32 preferably has the same shape as the recess shape but is of smaller dimensional extent to define a recessed ledge 36 adapted to receive and support the peripheral edges of the clear acrylic panel 20 defining a transparent surface portion in each corner of the vacuum chuck 18. The clear panel 20 is formed with a series of vacuum openings 38 (depicted only in FIG. 3) which are commonly connected to each other through a series of vacuum passageways 40 to apply vacuum and properly and firmly position the portion of the circuit board panel 14 containing the fiducial F in overlying relationship with the transparent portion 20. To that end, the top surface 42 of the clear panel 20 is preferably flush with the adjacent surrounding top surface of the vacuum chuck 18.

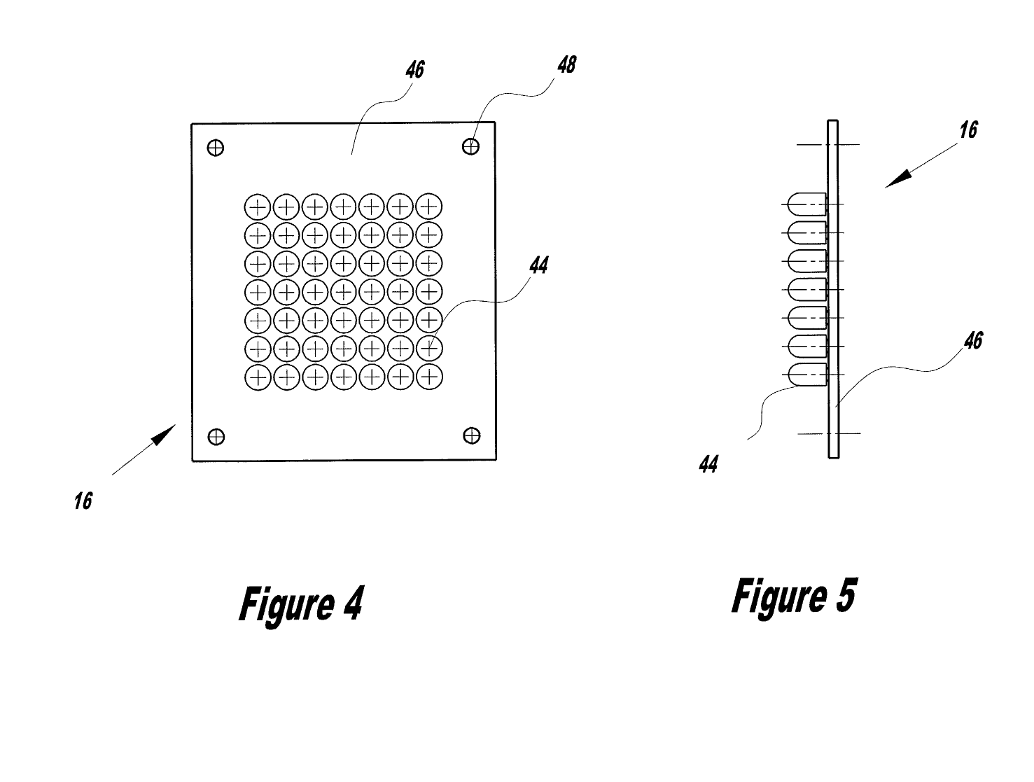

With reference to FIGS. 4 and 5, each lighting panel 16 is preferably comprised of a two dimensional array of individual light sources, such as a 7 by 7 array of super high intensity white LEDs 44 which are mounted to a board 46 formed with four corner mounting holes 48. The LEDs 44 are insertable into position beneath the clear panel 20 through the bottom surface of the vacuum chuck 18. Screws or other fasteners (not shown) are used to easily secure the mounting board 46 to the bottom surface of the chuck 18 so that the lighting array of LEDs 44 are in proper position within through opening 32 beneath the panel 20. When actuated, the lit array creates a back lighting area 30 (see FIG. 1) that is visible through the clear panel 20 to silhouette the fiducial F placed on top of the panel.

It is possible to utilize a single point light source instead of a light source formed from a plurality of light emitting elements and still realize the various benefits obtained in accordance with the principles of the present invention. However, the feature of utilizing a plurality of light emitting elements creates a more evenly distributed source of light with respect to silhouetting the fiducial F. The feature of utilizing plural light sources covering a predetermined surface area of greater dimensional extent than the size of the fiducial also advantageously allows circuit board panels of different size to be commonly mounted to the same vacuum chuck with their fiducials still overlying the associated transparent surface portions 20. In practice, it has been observed that a back lit area of 50 mm by 50 mm is sufficient to accommodate a number of differently sized boards by providing sufficient surface area for the fiducials F to be disposed and remain back lit.

It is also with in the scope of this invention to utilize a colored panel or a colored light source to silhoutte the fiducial.

The back lighting assemblies 10 may be used to illuminate the fiducials F of circuit board panels 14 in situations where the top and bottom panel surfaces above and below the fiducial is bare and free of any copper or metallic layer to enable the light to shine through the semi-opaque substrate material and illuminate the fiducial. By forming these bare areas 50 during earlier processing steps to be free of any metal, the present invention makes it possible to eliminate the need for skiving prior to initiating the drilling sequence. Accordingly, production drilling times are decreased and greater throughput is possible.

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

1. A method of precisely locating a printed circuit board panel containing at least one fiducial on a vacuum chuck of a drilling machine, comprising the steps of:
a. positioning the panel on the vacuum chuck;
b. projecting an image of the fiducial towards an overhead camera vision system by shining a light upwards through the fiducial from a source located below the panel; and
c. recording the position of the fiducial with the overhead camera vision system.

2. The method of claim 1, comprising the further step of positioning a predetermined area of the panel containing the fiducial over a transparent surface portion of the vacuum chuck, and shining the light upwards through the transparent surface portion.

3. The method of claim 2, comprising the further step of applying vacuum directly to the predetermined area through the transparent portion.

4. The method of claim 1, wherein the step of shining the light silhouettes or back lights fiducial.

5. The method of claim 2, wherein the predetermined area is bare and thereby formed without any copper or metallic layer.

6. The method of claim 5, wherein said predetermined area is made from a semi-opaque material.

7. The method of claim 1, wherein each corner of the panel has a fiducial, and comprising the further step of shining a light upward through each fiducial from an associated light source, and moving the overhead camera vision system over each backlit fiducial to record the position thereof.

8. The method of claim 2, wherein light from a plurality of light sources is directed through said transparent portion.

9. The method of claim 8, wherein said plurality of light sources is a two dimensional array of said light sources.

10. The method of claim 2, wherein said transparent surface portion is clear.

11. The method of claim 2, wherein said transparent surface portion is colored.

12. The method of claim 5, wherein the bare predetermined areas are formed without skiving.

13. A laser drilling apparatus, comprising:
a. a laser radiation source positioned for generating a laser beam;
b. a motorized table beneath the laser beam;
c. a vacuum chuck positioned on the table to receive a circuit board panel to be drilled;
d. a light source positioned below a panel support upper surface of the vacuum chuck for transmitting light upwardly to back light a portion of the panel containing the fiducial;
e. an overhead camera vision system for detecting the image of the fiducial to determine the exact positioning of the panel on the table; and
f. a scanner operatively connected to the camera vision system to point the laser beam to drill holes in precise predetermined locations in the panel.

14. The apparatus of claim 13, wherein said vacuum chuck includes a transparent surface portion and said light source is positioned beneath the transparent surface portion to shine light upwards there through.

15. The apparatus of claim 14, further comprising vacuum openings formed in said transparent surface portion, said openings being adapted to apply vacuum to suck the portion of the panel containing the fiducial tightly against the transparent surface portion.

16. The apparatus of claim 15, wherein said transparent surface portion is a clear panel.

17. The apparatus of claim 16, wherein said light source includes a plurality of lights positioned beneath the clear panel.

18. The apparatus of claim 17, wherein said plurality of lights are light emitting diodes (LEDs) in an m×n array.

19. The apparatus of claim 18, wherein m and n are integers having the same value.

20. The apparatus of claim 19, wherein m and n equal 7.

21. The apparatus of claim 19, wherein the surface area of the light source is smaller than the surface area of the transparent surface portion.

22. The apparatus of claim 17, wherein said lights are mounted to a mounting board that is releaseably attached into position beneath the clear panel through a mounting cavity communicating with a bottom surface of a vacuum chuck.
